(19) United States
(12) Patent Application Publication
(10) Pub. No.: US 2016/0297025 A1
(43) Pub. Date: Oct. 13, 2016

(54) SYSTEM FOR MONITORING AND CONTROLLING AIR QUALITY DURING WELDING

(71) Applicant: Lincoln Global, Inc., City of Industry, CA (US)

(72) Inventor: Edward A. Enyedy, Eastlake, OH (US)

(21) Appl. No.: 14/681,196

(22) Filed: Apr. 8, 2015

(51) Int. Cl. B23K 9/095; B23K 9/32; G06F 17/30; B23K 9/12

(52) U.S. Cl. CPC B23K 9/0953; B23K 9/0956; B23K 9/125; B23K 9/321; G06F 17/30392

(57) ABSTRACT

A fume reduction system includes an electric arc torch, a consumable wire electrode, an air quality sensor, and a power supply operatively connected to the electric arc torch and the air quality sensor. The air quality sensor monitors air quality near the electric arc torch and generates an air quality signal corresponding to the air quality. The power supply supplies electrical energy for generating the electrical arc and controls the wire feed speed of the consumable wire electrode. The power supply further receives the air quality signal and automatically reduces the wire feed speed from a first positive speed to a second positive speed based on the level of the air quality signal.

### BACKGROUND OF THE INVENTION

1. Field of the Invention

The present invention relates to arc welding systems, and in particular to a system for monitoring and controlling the air quality near a welding operator during arc welding.

2. Description of Related Art

Significant quantities of fumes, gases, vapors, dusts or the like (all of which are referred to herein as “fumes” or “welding fumes”) are typically produced as by-products of most welding processes. These fumes are created at various locations, such as around the welding gun when working proximate a workpiece or in the immediate vicinity of the welding operator. Some industrial regulations may require that the fumes be monitored and extracted from the work area with minimal or no adverse health effects to the welding operators. The health hazard potential related to welding fumes depends on the concentration and toxicity of the materials involved (types of metals, fluxes, gases, coatings, etc.), the length of exposure, the position of the welder's head with respect to the fumes, and the effectiveness of control measures, such as fume extraction, ventilation, and personal protective equipment.

Common ventilation methods include general (or ambient) ventilation that uses an HVAC system and/or high powered fans to move large quantities of air and dilute contaminants based on an air change schedule and local exhaust ventilation that captures and removes contaminants at their source, i.e., before they reach the welding operator's breathing zone. Both methods have disadvantages. For example, general ventilation does not always protect the welder's immediate breathing zone while local exhaust ventilation is less feasible in large welding areas. In addition, it is desirable that an extraction hood is close enough to the source of fumes while providing an unobstructed view at the welded work piece, and that the extraction device is portable in order to reach all portions of the welding area.

### BRIEF SUMMARY OF THE INVENTION

In accordance with one aspect of the present invention, provided is a fume reduction system. The fume reduction system includes an electric arc torch. A consumable wire electrode is operatively connected to the electric arc torch and receives electrical energy from the electric arc torch. The consumable wire electrode establishes an electrical arc between the consumable wire electrode and a workpiece. An air quality sensor monitors the air quality near the electric arc torch and generates an air quality signal corresponding to the air quality. A power supply is operatively connected to the electric arc torch and to the air quality sensor. The power supply is configured to supply electrical energy for generating an electrical arc at the electric arc torch. The power supply controls the wire feed speed of the consumable wire electrode by receiving the air quality signal and automatically changing the wire feed speed from a first positive speed to a second positive speed based on the level of the air quality signal.

In accordance with another aspect of the present invention, provided is a fume reduction system. The fume reduction system includes an electric arc torch. A consumable wire electrode is operatively connected to the electric arc torch and receives electrical energy from the electric arc torch. The consumable wire electrode establishes an electrical arc between the consumable wire electrode and a workpiece. An air quality sensor monitors the air quality near the electric arc torch and generates an air quality signal corresponding to the air quality. A power supply is operatively connected to the electric arc torch and to the air quality sensor. The power supply is configured to supply electrical energy for generating an electrical arc according to a programmed parameter. The programmed parameter may include at least one of arc voltage, arc current, and wire feed speed. The power supply receives the air quality signal and adjusts the programmed parameter based on the level of the air quality signal.

In accordance with another aspect of the present invention, provided is a fume reduction system. The fume reduction system includes an electric arc torch. A consumable wire electrode is operatively connected to the electric arc torch and receives electrical energy from the electric arc torch. The consumable wire electrode establishes an electrical arc between the consumable wire electrode and a workpiece. An air quality sensor monitors the air quality near the electric arc torch and generates an air quality signal corresponding to the air quality. A power supply is operatively connected to the electric arc torch and to the air quality sensor. The power supply is configured to supply electrical energy for generating an electrical arc according to a programmed parameter. The programmed parameter may include at least one of arc voltage, arc current, and wire feed speed. The power supply receives the air quality signal and adjusts the programmed parameter based on the level of the air quality signal. The fume reduction system also includes a powered air-purifying respirator (PAPR) having at least one fan with an automatically adjustable speed based on the air quality signal.

### BRIEF DESCRIPTION OF THE DRAWINGS

FIG. 1 is a schematic diagram of an example fume reduction system;

FIG. 2 is a flow chart illustrating the operation of the fume reduction system, according to an embodiment;

FIG. 3 is a schematic diagram of an example fume reduction system;

FIG. 4 is a perspective view of an electric arc torch with a fume extraction hose;

FIG. 5 is a perspective view of a PAPR welding helmet system;

FIG. 6 is a perspective view of the PAPR welding helmet system in use;

FIG. 7 is a schematic diagram of an example fume reduction system; and

FIG. 8 a schematic diagram of an example fume reduction system, according to an embodiment.

### DETAILED DESCRIPTION OF THE INVENTION

The present invention relates to monitoring and controlling the air quality near the welding operator in arc welding systems. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, the term “welding” refers to an arc welding process. Example arc welding processes include gas metal arc welding (GMAW), gas tungsten arc welding (GTAW), flux cored arc welding (FCAW), submerged arc welding (SAW), shielded metal arc welding (SMAW), metal cored arc welding (MCAW), plasma arc welding (PAW), and the like.

As used herein, the terms “electrode” and “welding electrode” refer to electrodes associated with a welding torch that transfer electrical energy from a welding power supply to a workpiece. Example “electrodes” and “welding electrodes” include consumable (e.g., wire or stick) electrodes that are consumed during welding, non-consumable electrodes (e.g., forming a part of a welding torch), and contact tips within a torch for transferring electrical energy to consumable electrodes. Movement of the electrode/welding electrode can refer to movements of the electrode relative to the welding torch and/or the workpiece, such as feeding a consumable wire electrode through the torch toward the workpiece. Movement of the electrode/welding electrode can also refer to movement of the torch itself, relative to the workpiece, along with the torch's contact tip or non-consumable electrode.

As used herein, the term “integrated” refers to being installed in, positioned on, being a physically integral part of, or being attached to (with or without the capability to be subsequently detached).

As used herein, the term “air quality” refers generally to the condition of the ambient air, such as the oxygen content in the breathable air near the welding operator and/or permissible levels of contaminants or other gases in the welding fumes (e.g., solid fume or smoke particles dispersed in the air in the vicinity of the welding operator). Although there is no standard for general welding fume levels, since 1993, OSHA has been enforcing the permissible exposure limits for each individual metal, metal oxide, or gas found in the welding fumes. Common metals in welding environments are for example Zinc, Iron, Chromium, Aluminum, Nickel, and Manganese (see 29 CFR 1910.1000 Table Z-1). Common gases in welding are carbon monoxide (CO), nitric oxide (NO) and nitrogen dioxide (NO₂) (also known generically as NOx). In 2006, OSHA issued its standard for exposure to hexavalent Chromium (see 29 CFR 1910.1026), setting a Permissible Exposure Limit (PEL) of 5 ug/m³ and an Action Level of 2.5 ug/m³. OSHA has placed exposure to Manganese (resulting primarily from welding exposures) on its list of intended regulatory actions.

As used herein, the term “PAPR” refers to a powered air-purifying respirator.

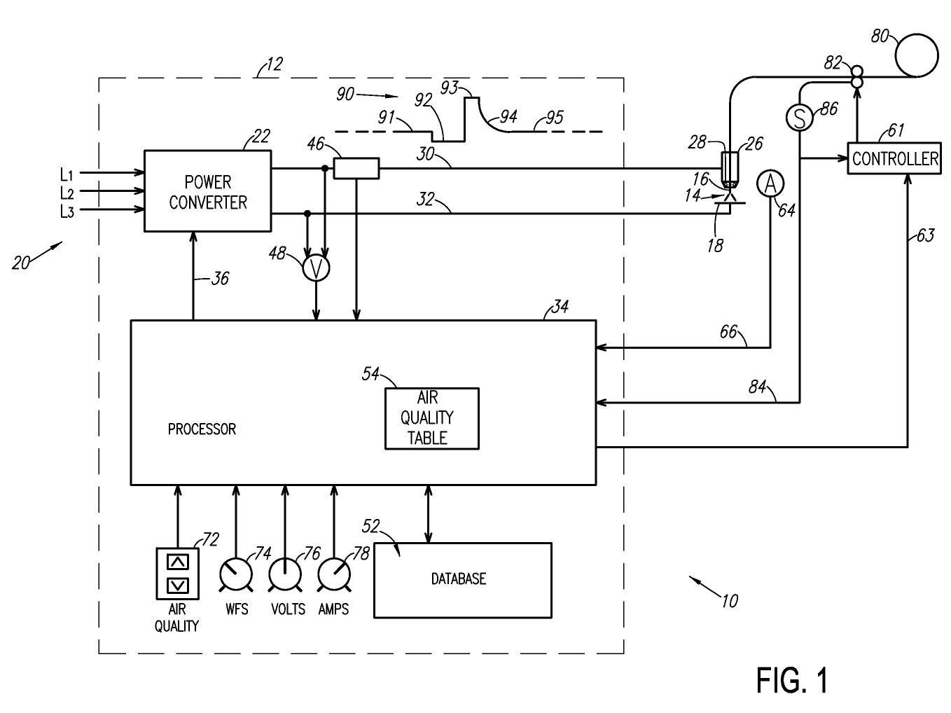

An example fume reduction system 10 is shown schematically in FIG. 1. The fume reduction system 10 includes a power supply 12. The power supply 12 generates an electric arc 14 between an electrode 16 and a workpiece 18 to perform a welding operation. The power supply 12 receives electrical energy for generating the electric arc 14 from a power source 20. The power source 20 can be a commercial electrical power source or a generator. The power source 20 can be a single phase or a three phase power source.

The power supply 12 may include a switching type power converter 22 for generating the arc according to a desired welding waveform. Example switching type power converters 22 include inverters, choppers, and the like.

The fume reduction system 10 includes an electric arc torch 26 that is operatively connected to the power converter 22. The power converter 22 supplies electrical energy to the electric arc torch 26 to perform the welding operation. In FIG. 1, the torch 26 has a contact tip 28 for transferring the electrical energy supplied by the power converter 22 to the electrode 16. It is to be appreciated that the electrode 16 can be either a consumable electrode extending from the electric arc torch 26 that is consumed during the welding operation, or a non-consumable electrode that is part of the electric arc torch 26.

Electrical leads 30, 32 provide a completed circuit for the arc welding current from the power converter 22 through the electric arc torch 26 and electrode 16, across the electric arc 14, and through the workpiece 18.

An air quality sensor 64 is installed near the electric arc torch 26. The air quality sensor 64 monitors the air quality, e.g., the oxygen content and/or the levels of contaminants or other gases in the welding fumes generated near the welding operator that are being breathed by the welding operator while performing the welding operations. The air quality sensor 64 may be positioned at or near the electric arc torch 26. For example, in certain embodiments, the air quality sensor 64 may be integrated in the electric arc torch 26 or in another piece of welding equipment used in the vicinity of the welding operator. In other embodiments, the air quality sensor 64 may be attached to a structure in the welding area, or may be integrated in the welding operator's protective clothing, welding helmet, or other protective equipment typically used in the vicinity of the electric arc torch 26 during the welding operation.

The air quality sensor 64 may be configured to monitor the air quality near the electric arc torch 26 at all times or at predetermined time intervals. For example, the air quality sensor 64 can be configured to sense the oxygen level in the air being breathed by the welding operator, or the levels of various contaminants. Based on the detected levels of oxygen and/or contaminants or gases, the air quality sensor 64 generates and transmits an air quality signal 66 to the power supply 12. The air quality signal 66 caries information related to the quality of the air near the welding operator. For example, the air quality signal 66 may include data about the oxygen content in the air and/or about the measured levels of different monitored metals, gases, and other contaminants that are part of the welding fumes generated near the welding operator. The air quality signal 66 can be an analog signal or a digital signal.

The power supply 10 includes a processor 34. The operation of the processor 34 is discussed in detail below. The processor 34 is operatively connected to the power converter 22 and provides a control signal 36 to the power converter 22. The processor 34 controls the output of the power converter 22 via the control signal 36. The processor 34 generates the control signal 36 according to the desired welding parameters and based on the input air quality signal 66 generated by the air quality sensor 64. The control signal 36 can comprise a plurality of separate control signals for controlling the operation of various switches (e.g., semiconductor switches) within the power converter 22. Further, the control signal 36 can be supplied to a separate controller (e.g., an inverter controller) that may be part of the power converter 22.

The processor 34 may be configured to monitor various aspects of the welding process via feedback signals. For example, a shunt 46 or a current transformer (CT) can provide a welding current feedback signal to the processor 34, and a voltage sensor 48 can provide a welding voltage feedback signal to the processor 34.

The processor 34 can include one or more of a microprocessor, a microcontroller, a digital signal processor (DSP), an application specific integrated circuit (ASIC), a field-programmable gate array (FPGA), discrete logic circuitry, or the like.

The processor 34 can be operatively connected to a database 52. The database 52 may be external to the processor 34 or may be an integrated part of the processor 34. The database 52 may include one or more memory portions (e.g., RAM or ROM). The memory portions may store a plurality of air quality tables 54 containing permissible values or ranges for various components of the air quality (e.g., the welding fumes) for use by the processor 34. For example, separate air quality tables may be used and each air quality table 54 may include a number of values for different metals or gases, such as carbon monoxide (CO), nitric oxide (NO) and nitrogen dioxide (NO₂), flammable or poisonous gasses (e.g., phosgene) that together define the composition of the fumes generated during the welding operation and the acceptable and/or desirable oxygen level in the breathable air near the welding operator.

The memory portion can also store a plurality of welding parameters (e.g., arc voltage, arc current, and wire feed speed). Each individual value of the fume components within the air quality table 54 may correspond to at least one welding parameter (e.g., arc voltage, arc current, wire feed speed, peak current, background current, etc.). This relationship allows the processor 34 to provide the functionality ascribed to it herein. For example, as described in detail below, based on the received air quality signal 66, the processor 34 would generate instructions to the power converter 22 or to the wire feed speed controller 61 and control the generated welding fumes. However, embodiments are not limited thereto and other configurations are possible.

For example, in certain embodiments, the processor 34 itself or the database 52 may include look-up tables that may be used by the processor 34 to look-up and calculate adjusted values of the welding parameters (e.g., arc voltage, arc current, wire feed speed, peak current, background current, etc.) based on the received air quality signal 66. Similarly, after the processor 34 adjusts the wire feed speed based on the received air quality signal 66, the welding voltage and the welding current may be calculated using look-up tables that may be stored either in the processor 34 or in the memory portion of the database 52.

In certain embodiments, the processor 34 can access a remote memory (not shown) that may store programs, tables with air quality values, and/or look-up tables with welding parameters for use by the processor 34. The processor 34 can access such a remote memory through a network, such as a local area network, a wide area network, the Internet, etc. Example remote memories include remote servers, cloud-based memories, etc.

During operation of the fume reduction system 10, the air quality sensor 64 may be configured to draw in air from the vicinity of the electric arc torch 26 and submit data related to the measured air quality to the processor 34. For example, using the monitored air quality, the air quality sensor 64 may generate an air quality signal 66 which would correspond to the detected air quality near the electric arc torch 26. The air quality sensor 64 then may transmit the air quality signal 66 to the processor 34 for analysis and further processing.

The connection between the air quality sensor 64 and the processor 34 may be implemented using a communication cable (e.g., a USB cable) and a communication input port (e.g., a USB port), or could be facilitated wirelessly via short-range wireless communications (e.g., Bluetooth). When the communication between air quality sensor 64 and the processor 34 is performed via wireless means, both the air quality sensor 64 and the processor 34 can have RF antennas for transmitting and respectively receiving the air quality signal 66. However, embodiments are not limited thereto and other configurations are possible. For example, other wireless means of communicating the air quality signal 66 between the air quality sensor 64 and the processor 34 may include infrared means, sonic means, or some other wireless means.

After the air quality signal 66 is received by the processor 34, the processor 34 analyzes the air quality signal 66. In certain embodiments, the air quality sensor 64 may include a laser photometer device capable of determining mass concentrations of various particles included in the sampled air. The mass concentrations may then be processed and included as part of the air quality signal 66, and analyzed by the processor 34. For example, the air quality sensor 64 may determine the oxygen content and the particle mass concentration in the sampled air and the processor 34 may compare the determined values to acceptable levels of the oxygen and the contaminants stored in a database. Moreover, the processor 34 may be configured to compare the air quality signal 66 with values of air quality signals stored in the air quality tables 54 in the memory portion of the power supply 12.

The analyzed air quality signal 66 can be used by the processor 34 for controlling the quality of the air and the welding fumes during the welding operation. For example, in the embodiment illustrated in FIG. 1, when the processor 34 determines that some components of the air quality signal 66 are outside predetermined acceptable values or ranges, the processor 34 may automatically generate instructions to the wire feed speed controller 61 to change (e.g., reduce or increase) the wire feed speed from a first positive speed to a second positive speed. The second positive wire feed speed may be a lower wire feed speed or a different wire feed speed that may be associated with a lower level of fumes generated during the welding operation. As a result, although the levels of some components of the quality of the air quality signal 66, as analyzed by the processor 34, may not be acceptable, the welding process will continue, albeit at a different, possibly slower pace. Therefore, the processor 34 would automatically change the wire feed speed from a first positive speed to a second positive speed based on the level of the air quality signal 66. After adjusting the wire feed speed, the processor 34 can automatically adjust other welding parameters (e.g., voltage, current) based on the adjusted wire feed speed. The processor 34 can increase the wire feed speed based on the level of the air quality signal 66, if it is expected that increasing the wire feed speed will result in an improved air quality during welding (e.g., result in fewer fumes). For example, shorting of the wire welding electrode 16 into the weld puddle might create spatter and fumes, whereas a spray process at a higher wire feed speed might result in fewer fumes.

In addition to adjusting a welding parameter such as wire feed speed, welding voltage, welding current, etc., portions of a periodic welding waveform can be adjusted based on the level of the air quality signal. An example welding waveform 90 is shown in FIG. 1. The welding waveform 90 can have any number of shapes formed by various states or phases of the weld cycle. For example, the welding waveform 90 can have a background current state 91 for maintaining the arc, a short clearing state 92, a peak current state 93, a tail-out current state 94, a ramp-up state with or without overshoot (not shown), etc. The welding waveform 90 can have associated time parameters, such as peak time, ramp-up rate, tail-out speed, etc. The processor 34 adjusts the waveform control signal 36 to achieve a welding operation in accordance with the desired welding waveform 91. Based on the level of the air quality signal 66, the processor 34 can adjust parameters of the welding waveform, such as peak current level, background current level, waveform frequency/period, waveform “balance” (e.g., ratio of the positive cycle to the negative cycle) to reduce fumes during welding and improve air quality.

FIG. 1 shows an example embodiment in which the processor 34 controls the wire feed speed (WFS) of the electrode 16. The electrode 16 is fed from a spool 80 by motor-operated pinch rollers 82. The motor-operated pinch rollers 82 are part of a wire feed speed control system for the electrode 16. The wire feed speed control system further includes a wire feed speed controller 61 (e.g., a motor controller) that operates the motor-operated pinch rollers 82. The wire feed speed controller 61 receives a wire feed speed control signal 63 from the processor 34, and the wire feed speed controller 61 adjusts the WFS in accordance with the wire feed speed control signal 63 received from the processor 34. The wire feed speed control signal 63 can be an analog signal or a digital signal.

Both the processor 34 and the wire feed speed controller 61 may receive a speed feedback signal 84 from a speed sensor 86 that may indicate the speed of the motor-operated pinch rollers 82 or the speed of the electrode 16. An example speed sensor 86 is an encoder or other rotational sensor that senses the actual speed of the pinch rollers, the speed of a motor driving the pinch rollers, or the speed of a gear for driving the pinch rollers. The speed sensor 86 could also directly measure the speed and or direction of the electrode 16.

During welding conditions when the level of oxygen is reduced, the levels of monitored contaminants and/or gases in the welding fumes are increased, or when there are indications of presence of flammable or poisonous gas near the welding operator, it is desirable that the welding parameters (e.g., arc current, arc voltage, wire feed speed) and the output of the air quality sensor 64 are constantly monitored and, if necessary, promptly adjusted. The fume reduction system shown in FIG. 1 allows sharing of information between the processor 34 and the air quality sensor 64 in real time, and the processor 34 can quickly make adjustments to the wire feed speed and the other welding parameters based on the air quality signal 66 received from the air quality sensor 64.

In certain embodiments, for example, when the processor 34 determines that the levels of components of the air quality signal 66 is unsafe or is approaching unsafe levels, the processor 34 may be configured to transmit instructions to the power supply 12 to turn off or shut down the welding power source and terminate the welding operation.

In other embodiments, the processor 34 may be configured to automatically extinguish the electrical arc if the air quality sensor 64 detects the presence of flammable gas. As used herein, the term “flammable gas” refers to flammable fuel gas, such as LP gas, natural gas, acetylene gas, methane, propane, butane, hydrogen and mixtures and combinations thereof.

The air quality sensor 64 may include a gas detector configured to detect the presence of a flammable gas by measuring the gas density near the electric arc torch 26. The result from the gas detector may be transmitted to the processor 34. When the presence of explosive, flammable or hazardous gases is detected by the gas detector, the processor 34 may be configured to automatically extinguish the electrical arc and shut down the welding operation. For example, the processor 34 may transmit an instruction to the power supply 12 to discontinue the supply of arc voltage or arc current. Optionally, the processor may disable the power supply 12 until flammable gas is no longer detected by the gas detector.

Alternatively, an additional sensor (not shown) that is separate from the air quality sensor 64 or a separate gas detector unit may be installed near the electric arc torch 26 and may be configured to detect the presence of flammable gas. The additional sensor or the separate gas detector unit may also transmit to the power supply 12 a signal that may be separate from the air quality signal 66 and that may only be used to indicate the presence of flammable gas. Similarly to the air quality sensor 64, the flammable gas sensor may be configured to monitor the presence of flammable gas near the electric arc torch 26 at all times or at predetermined time intervals.

As described above, the memory portion can store a plurality of welding parameters (e.g., arc voltage, arc current, wire feed speed, waveform shape and frequency, etc.) The memory portion can store a plurality of air quality tables 54 including acceptable values or ranges of various components of the air quality signal. The processor 34 can compare and analyze the values of monitored components of the air quality signal 66 by accessing the respective air quality tables 54. Based on the results of this analysis, the processor 34 can select a particular welding parameter for use in controlling the welding operation. For example, increased levels of contaminants or gases may require reduction in some of the welding parameters, for example, reducing the wire feed speed, the arc voltage, or the arc current. Thus, the processor 34 can select and/or modify an appropriate welding parameter automatically based on the air quality signal 66.

In certain embodiments, the processor 34 may reduce at least one welding parameter (e.g., the arc voltage, the arc current, or the wire feed speed) from a first level to a second level while the electrical arc is generated, based on the level of the air quality signal 66. The second level of the welding parameter may be a lower level compared to the first level of the welding parameter, or may simply be a different level that may be associated with a lower level of fumes generated during the welding operation. As a result, although the levels of some components of the quality of the air quality signal 66, as analyzed by the processor 34, may not be acceptable, the welding process will continue, albeit at a possibly slower pace. Therefore, the processor 34 would automatically adjust the welding parameter based on the level of the air quality signal 66.

The power supply 12 can also include a user interface 72 that would allow a welding operator to select a particular air quality (e.g., pre-set levels of oxygen and contaminants in the breathable air near the welding operator) and a particular welding parameter. For example, as illustrated in FIG. 1, the power supply 12 can include an input device 72 (e.g., user interface) that may allow a welding operator to select a particular air quality (e.g., levels of oxygen and contaminants in the breathable air near the welding operator). The power supply 12 can also include additional separate input devices (e.g., user interfaces) 74, 76, 78 for setting or modifying various welding parameters such as wire feed speed (WFS), welding voltage (Volts), welding current (Amps), etc. In certain embodiments, the power supply 12 may be configured to select a welding program from a single welding operator input device. Optionally, the power supply 12 can include an output device, such as a display, for informing the welding operator of the selected air quality, the selected welding program, of the selection of the various welding parameters, etc.

In certain embodiments, the user interface 72 may be operatively connected to the processor 34. The user interface 72 may be programmable by the welding operator to pre-set a desired level or range of the air quality signal 66. For example, the user interface 72 may be used by the welding operator to set one or more values or a range corresponding to the air quality signal 66 and the level of exposure to various contaminants that may be included in the welding fumes. A value corresponding to the exposure level can for example be a value corresponding to the level of contaminants in the fumes that may be compared to the values measured by the air quality sensor 64 and sent to and processed by the processor 34. The welding operator may rely on a standard maximum fume exposure guideline (MFEG) to determine an appropriate and/or desired exposure level for particular contaminants of the welding fumes and/or for a particular welding process, for example.

The user interface 72 may be a touch-sensitive display or a configuration of switches and/or buttons, for example. However, embodiments are not limited thereto and other types of user interfaces are possible.

In certain embodiments, additional user interfaces 74, 76, and 78 may be operatively connected to the processor 34. The additional user interfaces 74, 76, and 78 may be programmable by the welding operator to pre-set a desired level of the welding arc current, the welding arc voltage, and the wire feed speed.

In addition to receiving feedback signals, such as welding voltage, welding current, and the air quality signal 66, it is to be appreciated that the processor 34 can make use of numerous additional parameters in performing its control functions, such as analog and digital inputs from the welding system, the status of internal timers and flags, user interface 74, 76, 78 settings, etc.

In certain embodiments, the processor 34 can be configured to automatically select a particular welding parameter (e.g., voltage, current, wire feed speed) based on the air quality signal 66. The processor 34 can select a particular welding parameter, for example, by performing calculations and/or by using look-up tables stored in the processor 34 or in the database 52.

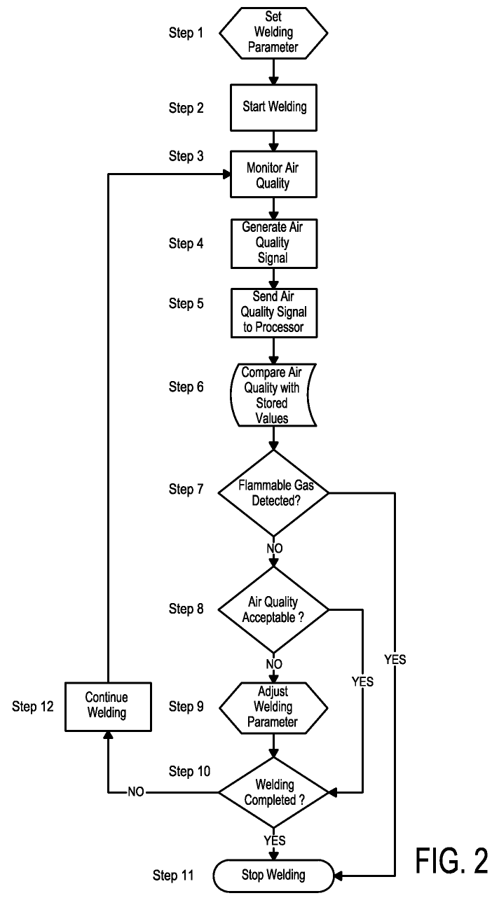

FIG. 2 provides a flowchart illustrating the operation of the fume reduction system 10 illustrated in FIG. 1.

In Step 1, the welding parameter is set by either an automated welding program or by the welding operator using user interface (illustrated in FIG. 1).

In Step 2, the welding process starts.

In Step 3, the air quality sensor 64 starts monitoring the air quality near the electric arc torch 26.

In Step 4, based on the monitored air quality near the electric arc torch 26, the air quality sensor 64 generates an air quality signal 66.

In Step 5, the air quality sensor 64 sends the air quality signal 66 to the processor 34 for analysis and further processing.

In Step 6, the processor 34 compares the air quality signal 66 with the values of various components of the air quality signal 66 that may be stored in the air quality tables 54, in the database 52, or in the processor 34.

In Step 7, if flammable gas is detected near the electric arc torch 26, the processor 34 sends instructions to the power supply 12 to extinguish the electric art and terminate the welding process. As noted above, the presence of flammable gas may be detected by the air quality sensor 64 or by a separate flammable gas detecting sensor.

In Step 8, based on the result of the comparison in Step 6, the processor 34 performs an analysis of whether the air quality signal 66 is within an acceptable range. This analysis may be performed, for example, by comparing the levels of oxygen that is present in the sampled air or by comparing the levels of the various contaminants or gases in the sampled air to the values of various components of the air quality signal 66 that may be stored in the air quality tables 54, in the database 52, or in a memory that may be a part of the processor 34. If the components of the air quality signal 66 are within acceptable ranges, the processor 34 sends an instruction to the power supply 12 to continue the welding process using the currently set welding parameter until the welding process is completed.

In Step 9, if the components of the air quality signal 66 are not within acceptable ranges, the processor 34 adjusts the welding parameter.

In Step 10, the processor 34 checks whether the welding process is completed.

In Step 11, if the welding is completed, the processor 34 sends an instruction to the wire feed speed controller 61 to stop feeding the wire, and to the power supply 12 to discontinue the supply of welding voltage, after which the welding process stops.

In Step 12, after the welding parameter is adjusted (Step 9), the welding and the monitoring of the air quality (Step 3) continues following the above-described steps.

In certain embodiments, the electric arc torch 26, which is a part of the fume reduction system 10, may include a fume extraction hose or conduit that may be integrated in the electric arc torch 26. The fume extraction hose may be configured to extract fumes generated during the welding operation.

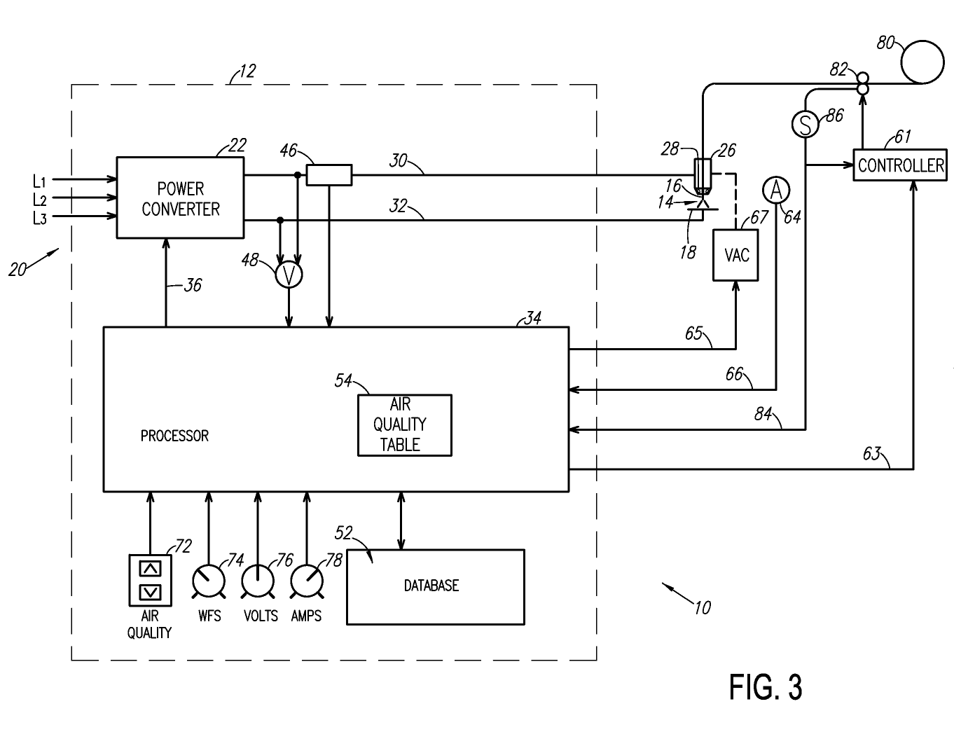

An example fume reduction system 10 with a fume extraction hose or conduit that may be integrated in the electric arc torch 26 is shown schematically in FIG. 3. The fume reduction system 10 includes the same components as the ones described in reference with FIG. 1 above (e.g. power supply 12, power source 20, electric arc 14, air quality sensor 64, etc.). In addition, the fume reduction system in FIG. 3 includes a vacuum system 67 that is operatively connected to the fume extraction hose or conduit that are integrated in the electric arc torch 26.

Similarly to the embodiment in FIG. 1, the air quality sensor 64 may be configured to monitor the air quality near the electric arc torch 26 and, based on the detected levels of oxygen and/or contaminants or gases, the air quality sensor 64 would generate and transmit an air quality signal 66 to the power supply 12 for adjusting the welding parameters. However, in the embodiment illustrated in FIG. 3, in addition to generating control signal 36 sent to the power converter 22 and wire feed speed control signal 63 sent to the wire feed speed controller 61, based on the input air quality signal 66 generated by the air quality sensor 64, the processor 34 also generates a fume control signal 65 to the vacuum system 67, which is operatively connected to the fume extraction hose or conduit that may be integrated in the electric arc torch 26. Like the control signal 36 and the wire feed speed control signal 63, the fume control signal 65 can be an analog signal or a digital signal.

In the embodiment illustrated in FIG. 3, when the processor 34 determines that some components of the air quality signal 66 are outside predetermined acceptable values or ranges, the processor 34 would automatically generate instructions to the vacuum system 67 to increase the speed of fume extraction and control the levels of the generated welding fumes. As a result, although the levels of some components of the air quality signal 66, as analyzed by the processor 34, may not be acceptable, the welding process will continue, while the fume extraction system operates at an increased pace.

Similarly to the embodiment illustrated in FIG. 1 and described above, the fume reduction system 10 shown in FIG. 3 allows sharing of information between the processor 34, the air quality sensor 64, and the vacuum system 67 in real time. As a result, the processor 34 can quickly make adjustments to the fume extraction speed based on the air quality signal 66 received from the air quality sensor 64.

In the fume reduction system 10 illustrated in FIG. 3, the processor 34 may control the wire feed speed (WFS) of the electrode 16 and the other welding parameters based on the air quality signal 66 in a similar manner as described above in reference with FIG. 1.

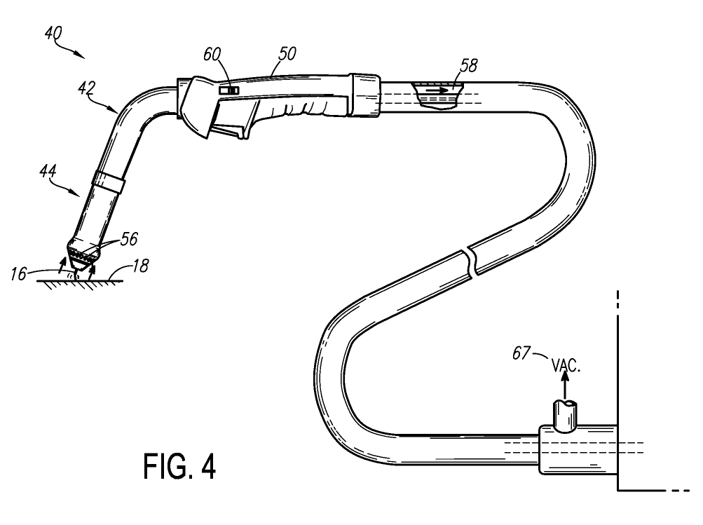

FIG. 4 shows an embodiment of a fume extraction hose integrated in the electric arc torch 26. The electric arc torch 26 includes a nozzle 44 with a plurality of fume extracting openings 56. Each fume extracting opening 56 is operatively connected to a passageway 42 that passes through the internal cavities of the nozzle 44 and the handle 50 of the electric arc torch 26, and continues through a vacuum hose 58 connected to a vacuum pump (not shown).

A switch 60 for actuating the fume extraction process may be provided in the handle 50 of the electric arc torch 26. In certain embodiments, the switch 60 may be operatively connected to the processor 34 in order to allow an automatic fume extraction based on an instruction from the processor 34 according to the received and analyzed air quality signal 66. The connection between the switch 60 and the processor 34 may be implemented using a communication cable (e.g., a USB cable) and a communication input port (e.g., a USB port), or could be facilitated wirelessly via short-range wireless communications (e.g., Bluetooth).

The speed and frequency of use of the fume extraction with the fume extraction hose 40 may be automatically controlled according to the air quality signal 66 in a similar manner as described above with reference to FIG. 1.

The vacuum pump may include an exhaust fan (not shown in FIG. 4) or other device that produces sufficient suction to remove welding fumes from the welding site. The exhaust fan may be configured to generate sufficient suction to remove airborne welding fumes from the welding site via the vacuum hose 58. The speed of the exhaust fan may also be automatically adjustable by the processor 34 based on the air quality signal 66.

Alternatively, the switch 60 may be configured to be activated by the welding operator for manual fume extraction. Other embodiments may allow a combination of an automatic and a manual fume extraction.

In certain embodiments, the air quality sensor 64 may be a part of a powered air-purifying respirator (PAPR). Example powered air-purifying respirators include PAPR welding helmets, face shields, hoods, head covers, and similar protective equipment. PAPR welding helmets are supplied with a flow of air from a blower to create a positive air pressure within the helmet. The positive air pressure helps keep environmental contaminants, such as welding fumes, out of the helmet, so that they are not inhaled by welding operator. The blower of the PAPR system is typically worn on the body of the welding operator, such as on a belt. An air hose connects the blower to the PAPR helmet. The blower can include one or more air filters for cleaning the air drawn from the welding environment.

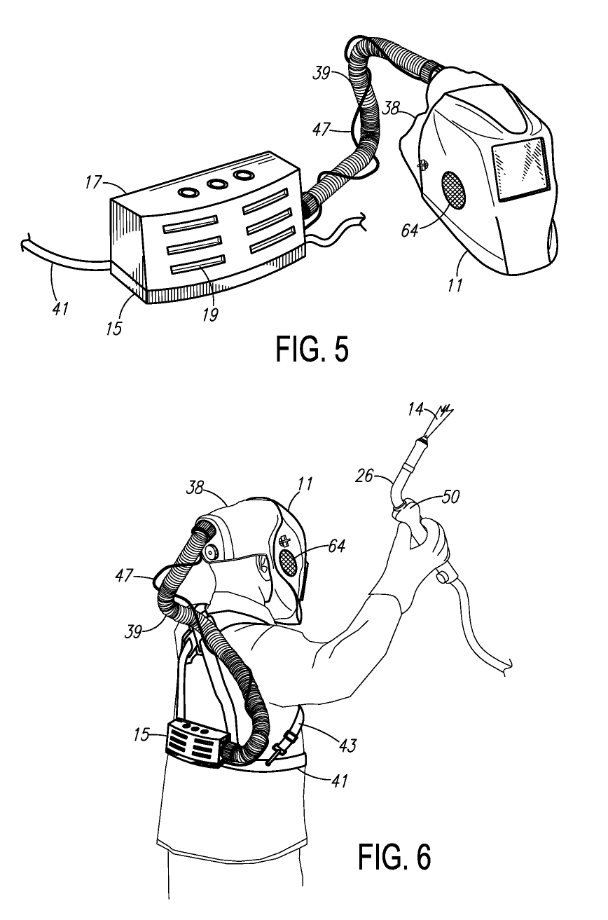

FIG. 5 provides a perspective view of an example PAPR welding helmet system. The system includes a helmet, such as a welding helmet 11, and a blower 15. The welding helmet 11 and the blower 15 are separate but interconnected devices that form parts of the PAPR system. A flexible air hose 39 connects the blower 15 to the welding helmet 11, and supplies pressurizing air from the blower to pressurize the welding helmet 11.

As further shown in FIG. 6, the blower 15 is worn by a welding operator. The blower 15 can be attached to a belt 41 and/or a shoulder harness 43 that may be worn by the operator at least partially around the trunk of his body. The blower 15 can be worn at the back of the operator, to minimize the welding fumes drawn in by the blower 15. The blower 15 may also have a fan (not shown) for drawing air from the environment into the blower 15 through a plurality of air intake ports 19. The blower 15 further may include one or more filters (not shown) for filtering airborne matter from the environment. For example, the blower 15 can include a pre-filter (e.g., a foam filter) followed by a HEPA filter (e.g., high-efficiency particulate air filter).

Turning back to FIG. 5, the welding helmet 11 can include a sealing hood 38 for establishing a pressurized environment around the face of the welding operator. A fan in the blower 15 pressurizes the blower enclosure 17, the flexible air hose 39 interconnecting the blower enclosure, the welding helmet 11, and the sealing hood 38 with air drawn from the environment.

The welding helmet 11 includes an air quality sensor 64 that may be integrated with the welding helmet 11. The air quality sensor 64 may be configured to measure the air quality near the welding operator and within the sealing hood 38 or within the welding helmet 11. As used with reference to this embodiment, the term “air quality” refers to both the permissible levels of contaminants in the welding fumes and to the quality of the air being breathed by the welder while wearing the welding helmet 11. The air quality sensor 64 may be located almost anywhere on the welding helmet 11 (e.g., on the front, left or right side, or toward the back of the welding helmet 11).

The air quality sensor 64 may be further configured to submit data related to the measured breathable air within the welding helmet 11 to the processor 34 using an air quality signal 66 (as previously shown in FIG. 1 and FIG. 3). The connection between the air quality sensor 64 and the processor 34 may be implemented using a communication cable (e.g., a USB cable) and a communication input port (e.g., a USB port), or could be facilitated wirelessly via short-range wireless communications (e.g., Bluetooth). Other wireless means of communicating the air quality signal between the air quality sensor 64 and the processor 34 may include infrared means, sonic means, or some other wireless means.

In the embodiment illustrated in FIG. 5, the air quality sensor 64 is positioned on the outside of the welding helmet 11. However, embodiments are not limited thereto and other configurations are possible. For example, in other embodiments, the air quality sensor 64 may be positioned inside the welding helmet 11 and may be either be permanently fixed on the welding helmet 11 or may be attachable to and detachable from the welding helmet 11.

Optionally, the air quality sensor 64 may include a user interface, a radio frequency (RF) antenna, and an alarm or an alert device.

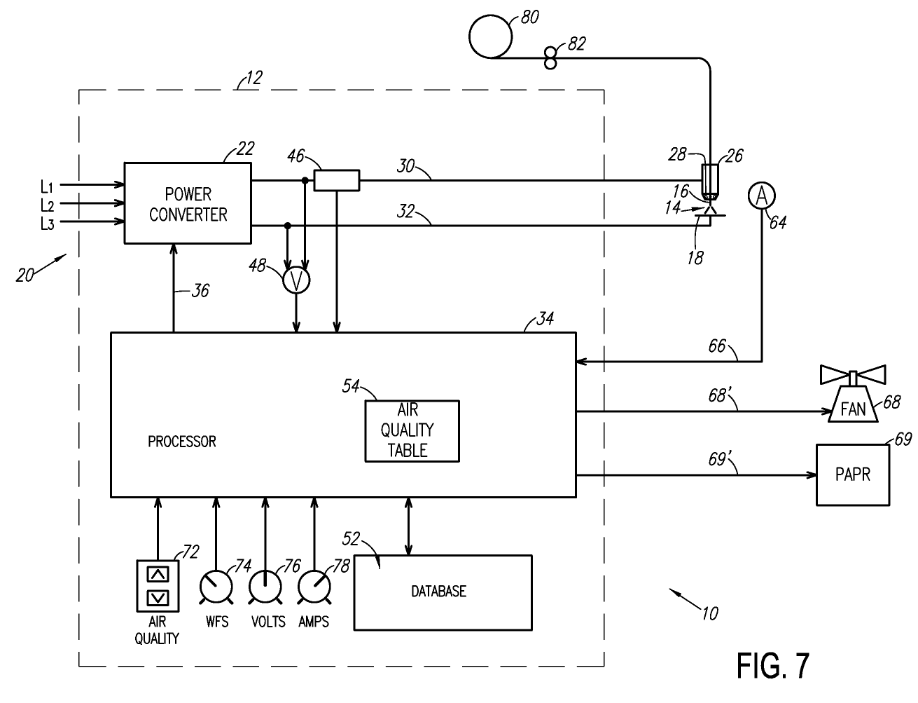

An example fume reduction system 10 with a fan 68 and a PAPR 69 is shown schematically in FIG. 7. The fume reduction system 10 shown in FIG. 7 includes the same components as the ones described in reference with FIG. 1 and FIG. 3 above (e.g. power supply 12, power source 20, electric arc 14, air quality sensor 64, etc.). The fan 68 may be a part of the vacuum pump mentioned with reference to in FIG. 4 or may be installed as a part of an exhaust hood that may either be a temporary structure or a removable component of the welding area.

Similarly to the embodiments in FIG. 1 and FIG. 3, the air quality sensor 64 may be configured to monitor the air quality near the electric arc torch 26 and, based on the detected levels of oxygen and/or contaminants or gases, the air quality sensor 64 would generate and transmit an air quality signal 66 to the power supply 12. However, in the embodiment illustrated in FIG. 7, in addition to generating control signal 36 to the power converter 22, the processor 34 also generates a fan control signal 68′ to the fan 68 and a PAPR control signal 69′ to the PAPR 69. Like the control signal 36, the fan control signal 68′ and the PAPR control signal 69′ can both be analog signals or digital signals.

When the processor 34 determines that one or more values of components of the air quality signal 66 are outside predetermined acceptable levels, the processor 34 may automatically generate instructions to adjust the speed of the fan 68 and/or the speed of the fan in the blower 15, which may be a part of the PAPR 69. For example, when the level of contaminants or gases exceeds permissible ranges, the processor 34 may increase the speed of the fan 68 to ensure faster extraction of the welding fumes from the welding area. The processor 34 may also increase the speed of the fan in the blower 15, and ensure drawing of additional air from the environment into the blower 15 through the plurality of air intake ports 19, thereby improving the quality of the air near the welding operator. Alternatively, when the level of contaminants or gases is below and/or within the permissible ranges, the processor 34 may reduce and/or maintain the current speed of the fan 68 and/or of the fan in the blower 15, and continue to remove welding fumes and/or draw air from the environment during the welding operation. Therefore, the processor 34 would automatically adjust the speed of the fan 68 and/or the speed of the fan in the blower 15 based on the level of the air quality signal 66. As a result, although the levels of some components of the air quality signal 66, as analyzed by the processor 34, may not be acceptable, the welding process will continue, while the fan 68 and/or the fan in the blower 15 would operate at an increased pace, welding fumes would be exhausted faster, and the welding helmet 11 would be supplied with an increased flow of air from the blower 15.

Similarly to the embodiments illustrated in FIG. 1 and FIG. 3, the fume reduction system 10 shown in FIG. 7 allows sharing of information between the processor 34, the air quality sensor 64, the fan 68, and the PAPR 69 in real time. As a result, the processor 34 can quickly make adjustments to the speed of the fan 68 and/or to the flow of air from the blower 15 to the welding helmet 11 based on the air quality signal 66 received from the air quality sensor 64.

In certain embodiments, information may be transmitted from the blower 15 to the welding helmet 11 and conveyed to the welding operator by the welding helmet 11. For example, turning briefly back to FIG. 5 and FIG. 6, information can be transmitted from the blower 15 to the welding helmet 11 via the conductor 47. The information could also be transmitted wirelessly via short-range wireless communications (e.g., Bluetooth). Transmitted information can include blower status, such as blower running (e.g., ON/OFF), blower fan speed, battery voltage, battery charge level, estimated remaining run time, filter status (e.g., blocked or clogged condition), etc. The information can be conveyed to the welding operator audibly and/or visually by the welding helmet 11. For example, the welding helmet can emit audible beeps to convey information to the welding operator.

In certain embodiments, the processor 34 may be configured to generate a warning or an alert indicating when certain pre-defined exposure level limits of components of the air quality signal are being exceeded. Such warning or alert may be sent to the welding operator or to an external station, such as a welding supervisor, safety personnel, or the like. The warning or alarm may be sent to an audible alarm device, a visual alarm device, or a combination of the two. The alarm device may be a part of the welding helmet 11. In other embodiments, the alarm device may be separate from the welding helmet 11 and may be wirelessly activated by the processor 34. However, embodiments are not limited thereto and other configurations are possible. For example, the warning or alarm may be sent to a vibrating alarm device that may be a part of the welding operator's clothing or other protective equipment. Alternatively, if the welding helmet 11 has an internal display that may be viewed by the welding operator, the warning information from the processor 34 may be displayed on the internal display.

In certain embodiments, the processor 34 may be configured to generate and store in its own memory or in the memory portion of the database 52 historical data regarding the air quality signal 66 and the contaminants levels to which a specific welding operator has been exposed during a specific period of time.

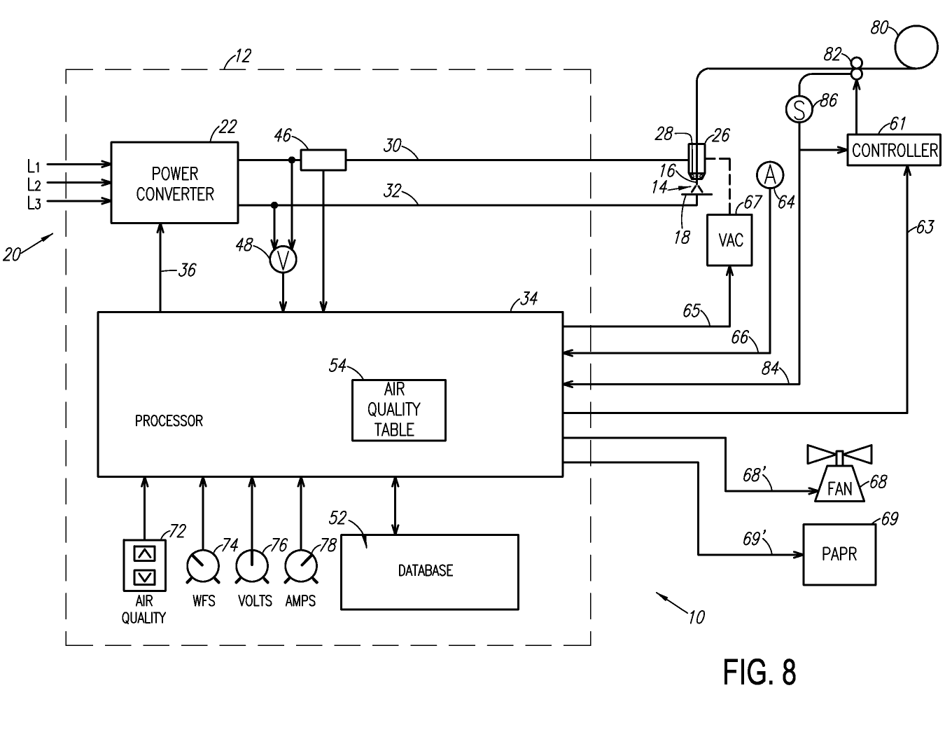

FIG. 8 shows a schematic example of a fume reduction system 10 with a fume extraction hose or conduit that may be integrated in the electric arc torch 26, a wire feed speed controller 61, a fan 68, and a PAPR 69. The fume reduction system 10 shown in FIG. 8 includes the same components as the ones described in reference with FIGS. 1, 3, and 7 above (e.g. power supply 12, power source 20, electric arc 14, air quality sensor 64, etc.).

Similarly to the embodiments in FIGS. 1, 3, and 7, the air quality sensor 64 may be configured to monitor the air quality near the electric arc torch 26 and, based on the detected levels of oxygen and/or contaminants or gases, the air quality sensor 64 would generate and transmit an air quality signal 66 to the power supply 12. In the embodiment illustrated in FIG. 8, based on the input air quality signal 66 generated by the air quality sensor 64, the processor 34 generates a control signal 36 sent to the power converter 22, a wire feed speed control signal 63 sent to the wire feed speed controller 61, a fan control signal 68′ sent to the fan 68, and a PAPR control signal 69′ sent to the PAPR 69. As noted above, all of the control signals generated by the processor 34 can be analog signals or digital signals.

In the embodiment illustrated in FIG. 8, when the processor 34 determines that some components of the air quality signal 66 are outside predetermined acceptable values or ranges, the processor 34 would automatically generate instructions to the vacuum system 67 to increase the speed of fume extraction and control the levels of the generated welding fumes. The processor 34 may also automatically generate instructions to adjust the speed of the fan 68 and/or the speed of the fan in the blower 15, which may be a part of the PAPR 69. As a result, although the levels of some components of the air quality signal 66, as analyzed by the processor 34, may not be acceptable, the welding process will continue, while the fume extraction system, the fan 68 and/or the fan in the blower 15 would operate at an increased pace, welding fumes would be exhausted faster, and the welding helmet 11 would be supplied with an increased flow of air from the blower 15.

In the fume reduction system 10 illustrated in FIG. 8, the processor 34 may also control the wire feed speed (WFS) of the electrode 16 and the other welding parameters based on the air quality signal 66 in a similar manner as described above in reference with FIG. 1.

Similarly to the embodiments illustrated in FIGS. 1, 3, and 7, the fume reduction system 10 shown in FIG. 8 allows sharing of information between the processor 34, the air quality sensor 64, the fan 68, and the PAPR 69 in real time. As a result, the processor 34 can quickly make adjustments to the fume extraction speed, to the speed of the fan 68 and/or to the flow of air from the blower 15 to the welding helmet 11, and/or to the wire feed speed, based on the air quality signal 66 received from the air quality sensor 64.

The fume reduction system 10 schematically shown in FIG. 8 includes most of the components and performs most of the control operations described separately above with reference to FIGS. 1, 3, and 7. However, embodiments are not limited thereto and other configurations of the fume reduction system 10 may include any combinations of the components and control features described above.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A fume reduction system, comprising:
an electric arc torch;
a consumable wire electrode, operatively connected to the electric arc torch, receiving electrical energy from the electric arc torch and establishing an electrical arc between the consumable wire electrode and a workpiece;
an air quality sensor for monitoring air quality near the electric arc torch and generating an air quality signal corresponding to the air quality;
a power supply operatively connected to the electric arc torch and the air quality sensor, wherein the power supply is configured to supply electrical energy for generating the electrical arc and control a wire feed speed of the consumable wire electrode, and wherein the power supply is further configured to receive the air quality signal and automatically change the wire feed speed from a first positive speed to a second positive speed based on a level of the air quality signal.

2. The fume reduction system of claim 1, wherein the wire feed speed is automatically reduced from the first positive speed to the second positive speed while the electrical arc is generated, based on the level of the air quality signal.

3. The fume reduction system of claim 1, wherein the power supply is configured to automatically extinguish the electrical arc if the air quality sensor detects a presence of a flammable gas.

4. The fume reduction system of claim 1, wherein the power supply comprises a processor configured to compare the level of the air quality signal to a range of levels of acceptable air quality signals stored in a database, and a user interface operatively connected to the processor and programmable by an operator to set a desired range of the air quality signal.

5. The fume reduction system of claim 1, wherein the electric arc torch comprises a fume extraction hose configured to extract fumes generated during a welding operation and wherein a fume extraction by the fume extraction hose is controlled according to the air quality signal.

6. The fume reduction system of claim 1, wherein the air quality sensor is a part of a powered air-purifying respirator (PAPR) comprising at least one fan with an automatically adjustable speed.

7. A fume reduction system, comprising:
an electric arc torch;
an electrode, operatively connected to the electric arc torch, receiving electrical energy from the electric arc torch and establishing an electrical arc between the electrode and a workpiece;
an air quality sensor for monitoring air quality near the electric arc torch and generating an air quality signal corresponding to the air quality;
a power supply operatively connected to the electric arc torch and the air quality sensor, wherein the power supply is configured to supply electrical energy for generating the electrical arc according to a programmed parameter, the programmed parameter including at least one of arc voltage, arc current, and wire feed speed, and wherein the power supply is configured to receive the air quality signal and adjust the programmed parameter based on a level of the air quality signal.

8. The fume reduction system of claim 7, wherein the at least one of the arc voltage, arc current, and wire feed speed is changed from a first level to a second level while the electrical arc is generated, based on the level of the air quality signal.

9. The fume reduction system of claim 7, wherein the power supply is configured to automatically extinguish the electrical arc if the air quality sensor detects a presence of a flammable gas.

10. The fume reduction system of claim 7, wherein the power supply comprises a processor configured to compare the level of the air quality signal to a range of levels of acceptable air quality signals stored in a database, and a user interface operatively connected to the processor and programmable by an operator to set a desired range of the air quality signal.

11. The fume reduction system of claim 7, wherein the electric arc torch comprises a fume extraction hose configured to extract fumes generated during a welding operation and wherein a fume extraction by the fume extraction hose is controlled according to the air quality signal.

12. The fume reduction system of claim 7, wherein the air quality sensor is a part of a powered air-purifying respirator (PAPR) comprising at least one fan with an automatically adjustable speed.

13. The fume reduction system of claim 7, wherein the power supply is configured to adjust a waveform shape of a periodic welding waveform based on the level of the air quality signal.

14. A fume reduction system, comprising:
an electric arc torch;
an electrode, operatively connected to the electric arc torch, receiving electrical energy from the electric arc torch and establishing an electrical arc between the electrode and a workpiece;
an air quality sensor for monitoring air quality near the electric arc torch and generating an air quality signal corresponding to the air quality;
a power supply operatively connected to the electric arc torch and the air quality sensor, wherein the power supply is configured to supply electrical energy for generating the electrical arc according to a programmed parameter, the programmed parameter including at least one of arc voltage, arc current, and wire feed speed, and wherein the power supply is configured to receive the air quality signal and adjust the programmed parameter based on a level of the air quality signal, and
a powered air-purifying respirator (PAPR) comprising at least one fan with an automatically adjustable speed based on the air quality signal.

15. The fume reduction system of claim 14, wherein the at least one of the arc voltage, arc current, and wire feed speed is reduced from a first level to a second level while the electrical arc is generated, based on the level of the air quality signal.

16. The fume reduction system of claim 14, wherein the power supply is configured to automatically extinguish the electrical arc if the air quality sensor detects a presence of a flammable gas.

17. The fume reduction system of claim 14, wherein the power supply comprises a processor configured to compare the level of the air quality signal to a range of levels of acceptable air quality signals stored in a database, and a user interface operatively connected to the processor and programmable by an operator to set a desired range of the air quality signal.

18. The fume reduction system of claim 14, wherein the electric arc torch comprises a fume extraction hose configured to extract fumes generated during a welding operation and wherein a fume extraction by the fume extraction hose is controlled according to the air quality signal.

19. The fume reduction system of claim 14, wherein the power supply is configured to automatically change the wire feed speed from a first positive speed to a second positive speed based on the level of the air quality signal.

20. The fume reduction system of claim 14, wherein the power supply is configured to adjust a waveform shape of a periodic welding waveform based on the level of the air quality signal.
